(19) United States
(12) Patent Application Publication
(10) Pub. No.: US 2026/0323035 A1
(43) Pub. Date: Oct. 15, 2026

(54) ADAPTATION OF INTERMEDIATE CODING INFORMATION WHEN AN ORIENTATION OF A PICTURE IS CHANGED

(71) Applicant: Tencent America LLC, Palo Alto, CA (US)

(72) Inventors: Biao WANG, San Jose, CA (US); Shan LIU, San Jose, CA (US); Roman CHERNYAK, Santa Clara, CA (US); Yonguk YOON, Palo Alto, CA (US); Lien-Fei CHEN, Palo Alto, CA (US); Yifan WANG, Palo Alto, CA (US); Ziyue XIANG, Palo Alto, CA (US)

(73) Assignee: Tencent America LLC, Palo Alto, CA (US)

(21) Appl. No.: 19/578,847

(22) Filed: Mar. 25, 2026

Related U.S. Application Data
(60) Provisional application No. 63/780,278, filed on Mar. 29, 2025.

(51) Int. Cl. H04N 19/136; H04N 19/11; H04N 19/172

(52) U.S. Cl. CPC H04N 19/136; H04N 19/11; H04N 19/172

(57) ABSTRACT

A method for video encoding includes adjusting an orientation of a first picture from an original orientation to an adjusted orientation. The method includes encoding, in a bitstream, the adjusted first picture in the adjusted orientation. The method includes generating unified intermediate coding information of the first picture based on a unified orientation of a plurality of pictures in a picture buffer. The plurality of pictures in the picture buffer is oriented in the unified orientation. The unified intermediate coding information is stored in one or more intermediate coding information buffers associated with the first picture. The unified orientation is one of (i) the original orientation and (ii) the adjusted orientation. The method includes encoding, in the bitstream, a second picture based on the unified intermediate coding information of the first picture.

### RELATED APPLICATION

The present application claims the benefit of priority to U.S. Provisional Application No. 63/780,278, “ADAPTATION OF INTERMEDIATE CODING INFORMATION WHEN A PICTURE IS CODED IN A FLIPPED DIRECTION IN VIDEO CODING,” filed on Mar. 29, 2025, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

### SUMMARY

Aspects of the disclosure provide a method for video encoding. The method includes adjusting an orientation of a first picture from an original orientation to an adjusted orientation. The method includes encoding, in a bitstream, the adjusted first picture in the adjusted orientation. The method includes generating unified intermediate coding information of the first picture based on a unified orientation of a plurality of pictures in a picture buffer. The plurality of pictures in the picture buffer is oriented in the unified orientation. The unified intermediate coding information is stored in one or more intermediate coding information buffers associated with the first picture. The plurality of pictures in the picture buffer includes the first picture. The unified orientation is one of (i) the original orientation and (ii) the adjusted orientation. The method includes encoding, in the bitstream, a second picture based on the unified intermediate coding information of the first picture.

Aspects of the disclosure also provide an apparatus for video encoding. The apparatus for video encoding includes processing circuitry configured to implement any of the described methods for video encoding.

Aspects of the disclosure also provide a method for video decoding. The method includes receiving a bitstream including information indicating that an orientation of a first picture is adjusted from an original orientation to an adjusted orientation. The method includes decoding the adjusted first picture in the adjusted orientation. The method includes generating unified intermediate coding information of the first picture based on a unified orientation of a plurality of pictures in a picture buffer. The plurality of pictures in the picture buffer is oriented in the unified orientation. The unified intermediate coding information is stored in one or more intermediate coding information buffers associated with the first picture. The plurality of pictures in the picture buffer includes the first picture. The unified orientation is one of (i) the original orientation and (ii) the adjusted orientation. The method includes decoding a second picture based on the unified intermediate coding information of the first picture.

Aspects of the disclosure also provide an apparatus for video decoding. The apparatus for video decoding includes processing circuitry configured to implement any of the described methods for video decoding.

Aspects of the disclosure also provide a non-transitory computer-readable storage medium storing instructions which when executed by a processor cause the processor to perform a method of encoding a bitstream. The method includes adjusting an orientation of a first picture from an original orientation to an adjusted orientation. The method includes encoding, in the bitstream, the adjusted first picture in the adjusted orientation. The method includes generating unified intermediate coding information of the first picture based on a unified orientation of a plurality of pictures in a picture buffer. The plurality of pictures in the picture buffer is oriented in the unified orientation. The unified intermediate coding information is stored in one or more intermediate coding information buffers associated with the first picture. The plurality of pictures in the picture buffer includes the first picture. The unified orientation is one of (i) the original orientation and (ii) the adjusted orientation. The method includes encoding, in the bitstream, a second picture based on the unified intermediate coding information of the first picture. The bitstream is transmitted.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of intra prediction modes according to an aspect of the disclosure.

FIG. 5 shows an example where a picture is vertically flipped.

FIG. 6 shows an example of misalignment for the intermediate coding information between a flipped picture (POC 0) and a non-flipped picture (POC 16) according to an aspect of the disclosure.

FIG. 7 shows an example of an aligned inheritance of intermediate coding information including block vector (BV) according to an aspect of the disclosure.

FIG. 8 shows an example of an aligned inheritance of intermediate coding information including model parameters that are derived from a template according to an aspect of the disclosure.

FIG. 9 shows an example of an aligned inheritance of intermediate coding information including model parameters that are derived from a reference area indicated by a BV according to an aspect of the disclosure.

FIG. 10 shows an example of remapping an intra prediction mode (IPM) when back-flipping the coding information buffer that stores the IPM according to an aspect of the disclosure.

FIG. 11 shows examples of positions for a back-flipping operation in the in-loop filters according to an aspect of the disclosure.

FIG. 12 shows a flow chart outlining a process according to an aspect of the disclosure.

FIG. 13 shows a flow chart outlining a decoding process according to some aspects of the disclosure.

FIG. 14 is a schematic illustration of a computer system in accordance with an aspect.

### DETAILED DESCRIPTION

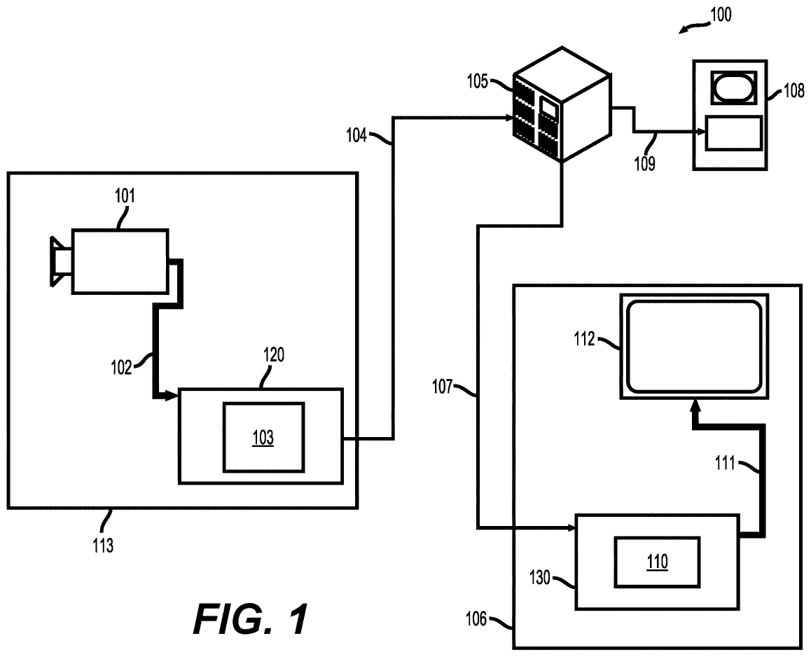

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other video enabled applications, including, for example, video conferencing, digital TV, streaming services, storing of compressed video on digital media including CD, DVD, memory stick and the like, and so on.

The video processing system (100) includes a capture subsystem (113), that may include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) may be encoded according to certain video coding/compression standards. Examples of those standards include ITU-T Recommendation H.265 and Versatile Video Coding (VVC). The disclosed subject matter may be used in the context of VVC.

It is noted that the electronic devices (120) and (130) may include other components (not shown). For example, the electronic device (120) may include a video decoder (not shown) and the electronic device (130) may include a video encoder (not shown) as well.

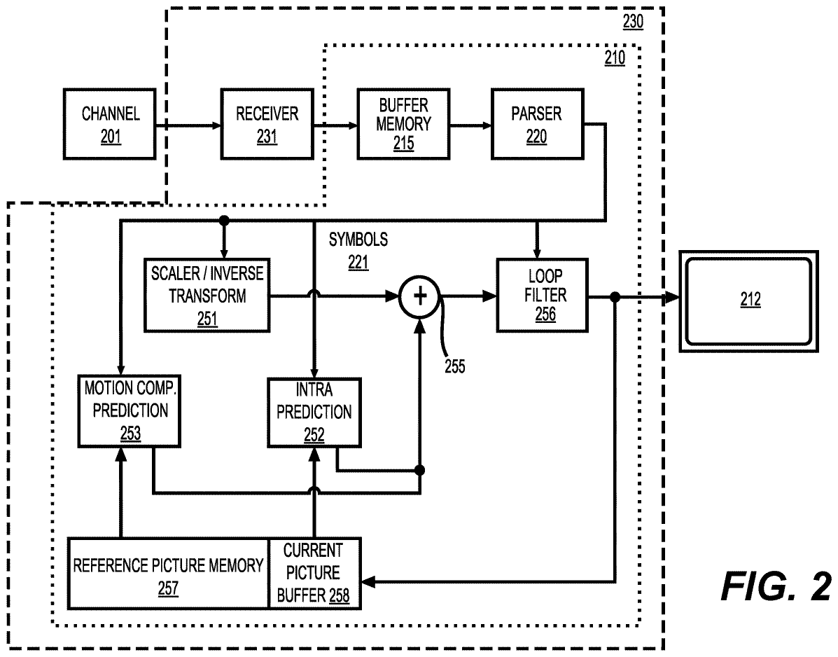

FIG. 2 shows an example of a block diagram of a video decoder (210). The video decoder (210) may be included in an electronic device (230). The electronic device (230) may include a receiver (231) (e.g., receiving circuitry). The video decoder (210) may be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it may be outside of the video decoder (210) (not depicted). In still others, there may be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or may be small. For use on best effort packet networks such as the Internet, the buffer memory (215) may be required, may be comparatively large and may be advantageously of adaptive size, and may partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but may be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence may be in accordance with a video coding technology or standard, and may follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups may include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) may involve multiple different units depending on the type of the coded video picture or parts thereof (such as: inter and intra picture, inter and intra block), and other factors. Which units are involved, and how, may be controlled by subgroup control information parsed from the coded video sequence by the parser (220). The flow of such subgroup control information between the parser (220) and the multiple units below is not depicted for clarity.

Beyond the functional blocks already mentioned, the video decoder (210) may be conceptually subdivided into a number of functional units as described below. In a practical implementation operating under commercial constraints, many of these units interact closely with each other and may, partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) may output blocks comprising sample values, that may be input into aggregator (255).

In some cases, the output samples of the scaler/inverse transform unit (251) may pertain to an intra coded block. The intra coded block is a block that is not using predictive information from previously reconstructed pictures, but may use predictive information from previously reconstructed parts of the current picture. Such predictive information may be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) may pertain to an inter coded, and potentially motion compensated, block. In such a case, a motion compensation prediction unit (253) may access reference picture memory (257) to fetch samples used for prediction. After motion compensating the fetched samples in accordance with the symbols (221) pertaining to the block, these samples may be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples may be controlled by motion vectors, available to the motion compensation prediction unit (253) in the form of symbols (221) that may have, for example X, Y, and reference picture components. Motion compensation also may include interpolation of sample values as fetched from the reference picture memory (257) when sub-sample exact motion vectors are in use, motion vector prediction mechanisms, and so forth.

The output samples of the aggregator (255) may be subject to various loop filtering techniques in the loop filter unit (256). Video compression technologies may include in-loop filter technologies that are controlled by parameters included in the coded video sequence (also referred to as coded video bitstream) and made available to the loop filter unit (256) as symbols (221) from the parser (220). Video compression may also be responsive to meta-information obtained during the decoding of previous (in decoding order) parts of the coded picture or coded video sequence, as well as responsive to previously reconstructed and loop-filtered sample values.

The output of the loop filter unit (256) may be a sample stream that may be output to the render device (212) as well as stored in the reference picture memory (257) for use in future inter-picture prediction.

Certain coded pictures, once fully reconstructed, may be used as reference pictures for future prediction. For example, once a coded picture corresponding to a current picture is fully reconstructed and the coded picture has been identified as a reference picture (by, for example, the parser (220)), the current picture buffer (258) may become a part of the reference picture memory (257), and a fresh current picture buffer may be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile may select certain tools as the only tools available for use under that profile from all the tools available in the video compression technology or standard. Also necessary for compliance may be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels may, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data may be in the form of, for example, temporal, spatial, or signal noise ratio (SNR) enhancement layers, redundant slices, redundant pictures, forward error correction codes, and so on.

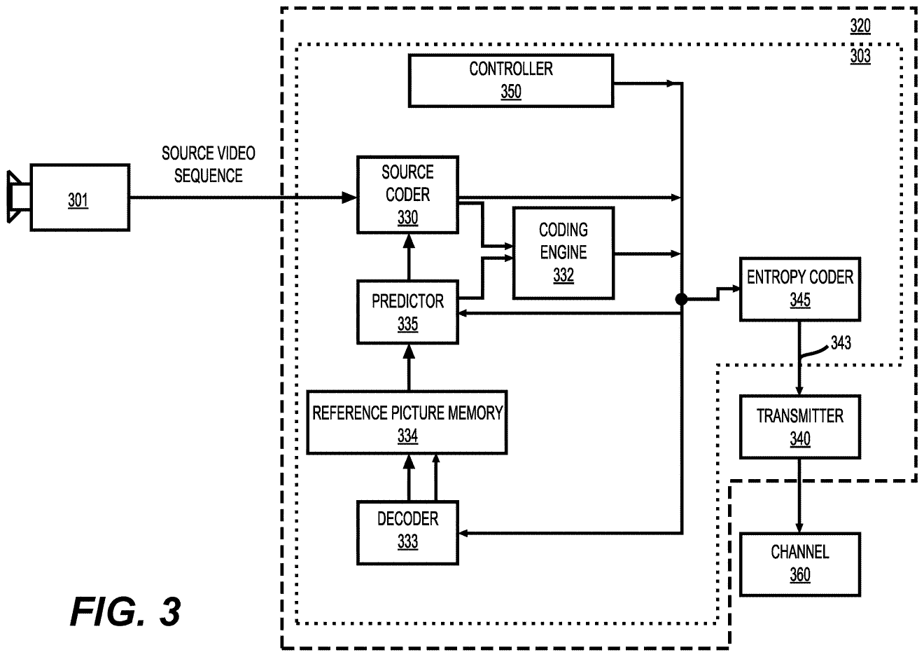

FIG. 3 shows an example of a block diagram of a video encoder (303). The video encoder (303) is included in an electronic device (320). The electronic device (320) includes a transmitter (340) (e.g., transmitting circuitry). The video encoder (303) may be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that may be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel may include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) may include rate control related parameters (picture skip, quantizer, lambda value of rate-distortion optimization techniques, . . . ), picture size, group of pictures (GOP) layout, maximum motion vector search range, and so forth. The controller (350) may be configured to have other suitable functions that pertain to the video encoder (303) optimized for a certain system design.

In some aspects, the video encoder (303) is configured to operate in a coding loop. As an oversimplified description, in an example, the coding loop may include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) may be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies may be abbreviated as they are the inverse of the comprehensively described decoder technologies. In certain areas, a more detailed description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures may use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture may be coded by a vector that is referred to as a motion vector. The motion vector points to the reference block in the reference picture, and may have a third dimension identifying the reference picture, in case multiple reference pictures are in use.

In some aspects, a bi-prediction technique may be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture may be coded by a first motion vector that points to a first reference block in the first reference picture, and a second motion vector that points to a second reference block in the second reference picture. The block may be predicted by a combination of the first reference block and the second reference block.

Further, a merge mode technique may be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU may be recursively quadtree split into one or multiple coding units (CUs). For example, a CTU of 64×64 pixels may be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) may be implemented using any suitable technique. In an aspect, the video encoders (103) and (303) and the video decoders (110) and (210) may be implemented using one or more integrated circuits. In another aspect, the video encoders (103) and (303), and the video decoders (110) and (210) may be implemented using one or more processors that execute software instructions.

Video coding has been widely used in many applications such as broadcasting, video recording, video streaming, and the like. Various video coding standards such as H.264, H.265/HEVC, H.266/VVC, AV1, AVS, and the like have been adopted. A video codec may include various modules, including, for example, intra prediction, inter prediction, transform coding, quantization, entropy coding, in-loop filtering, and the like.

According to aspects of the disclosure, methods, apparatuses, and non-transitory computer-readable storage mediums are provided for adapting intermediate coding information when an orientation of a picture is changed during video coding. An aspect of this disclosure includes adaptation of intermediate coding information when a picture is coded in a flipped direction in video coding.

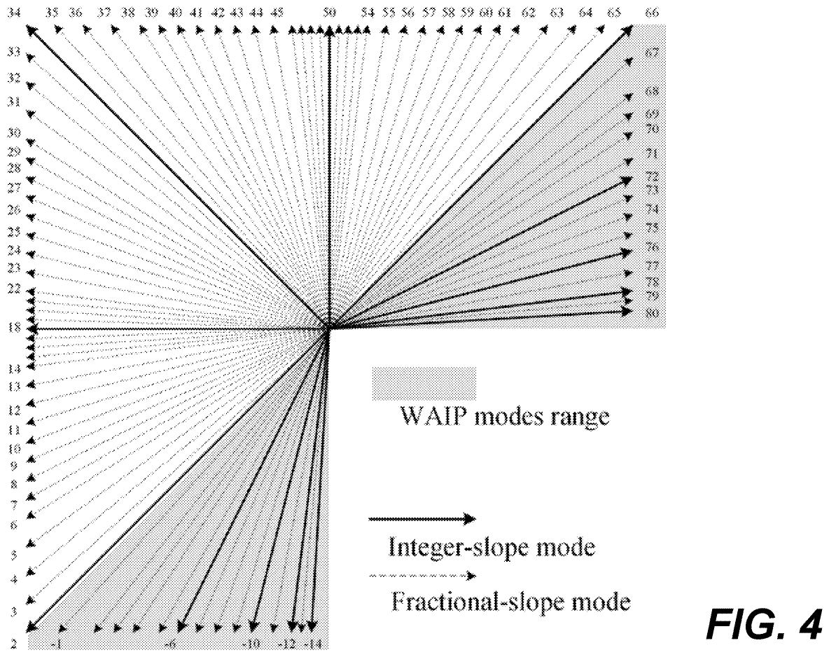

Intra prediction may be used in video coding. Intra prediction techniques may include the DC and planar modes such as used in HEVC and VVC, additional finer-granularity angular prediction with more angles compared to HEVC, e.g., a number of angular prediction modes may be used increased from 33 in HEVC to 93, such as shown in FIG. 4. FIG. 4 shows an example of intra prediction modes according to an aspect of the disclosure. The intra prediction modes indicated by the solid arrows are integer-slope modes, such as the intra prediction modes having mode numbers such as 18, 34, 50, and the like. For example, the integer-slope modes correspond to angular directions whose projection falls on integer reference sample positions, and thus fractional interpolation is not needed.

The intra prediction modes indicated by the dashed arrows are fractional-slope modes, such as the intra prediction modes having mode numbers such as 22, 33, 35, and the like. The angular directions corresponding to the fractional-slope modes project to fractional positions and thus interpolation (e.g., via interpolation filters) of the reference line is used to generate the fractional samples along the chosen direction.

In addition, the intra prediction modes indicated by the mode numbers in a first range from 2 to 66 (e.g., an angular range from −135° to +45° ) are not wide angular modes. Referring to FIG. 4, −135° corresponds to the mode number 2 and +45° corresponds to the mode number 66. The intra prediction modes indicated by the mode numbers that are outside the first range, such as from −14 to −1 or from 67 to 80, are wide-angle intra prediction (WAIP) modes, and the range is referred to as a WAIP mode range, e.g., marked in gray color in FIG. 4. In an example, the WAIP adapts angular directions for non-square blocks and thus the prediction uses “wider” angles (e.g., angles beyond the −135° to +45° range), for example, to better align with the block's aspect ratio and nearby reference samples.

An aspect of this disclosure describes an approach for adapting intermediate coding information when a picture is coded in an adjusted orientation in video coding. The adjusted orientation may also be referred to as an adjusted direction of the picture. In an example, the picture is flipped, and the adjusted orientation is a flipped direction.

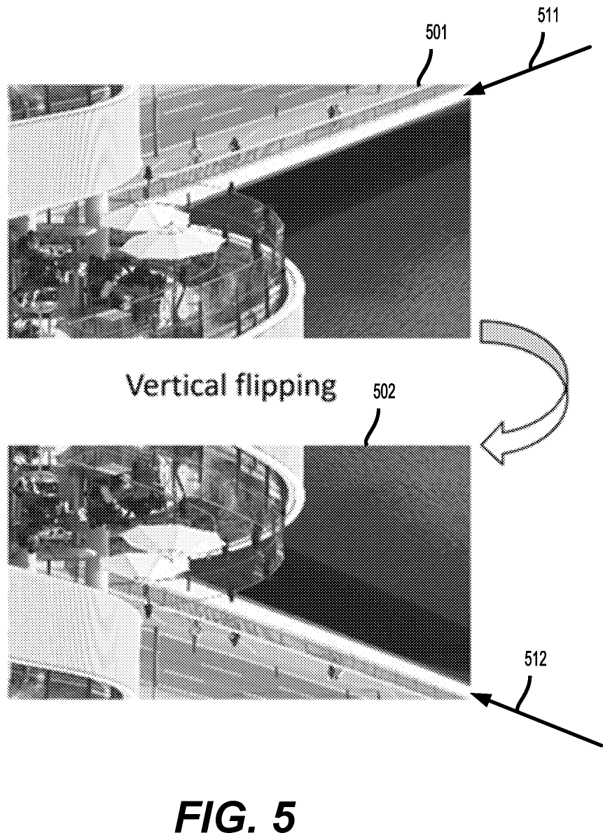

In some examples, flipping a picture whose layout is not aligned with a fixed direction, e.g., an intra prediction direction that is from a top-left to bottom-right, may bring coding performance improvement. FIG. 5 shows an example where a picture is vertically flipped. In an example, a picture (501) is determined as not oriented in the fixed direction (e.g., the direction that is from the top-left to the bottom-right of the picture), and thus the picture (501) is not aligned with the fixed direction.

Whether the picture (501) is aligned with the fixed direction or is oriented in the fixed direction may be determined as below. A filter (e.g., a Sobel filter) may be applied to samples in the picture (501) to determine directions (e.g., edge directions) in the picture (501). A dominant direction of the picture (501) may be determined based on the directions in the picture (501). For example, a histogram of directions that shows a relationship between the directions and respective frequencies of occurrences of the directions is determined, and the dominant direction is determined as, for example, the direction with the largest frequency of occurrences among the directions. This dominant direction is considered as the original orientation (also referred to as the original direction) of the picture (501). In some examples, when the original orientation is within a range from a first direction to a second direction that includes the fixed direction, the picture (501) is determined as aligned with the fixed direction or oriented in the fixed direction. Referring back to FIG. 4, in an example, the first direction is 180° corresponding to the mode number 18 and the second direction is 90° corresponding to the mode number 50, and the range is from 180° to 90°. In some examples, if the original orientation is within the range, there is no adjustment to the orientation of the picture (501), and if the original orientation is outside the range, then the orientation of the picture (501) is adjusted or modified, for example, the picture (501) is flipped horizontally, flipped vertically, and/or rotated to align the picture (501) to the direction corresponding to the mode number 34 in FIG. 4.

Referring to FIG. 5, the original direction of the picture (501) is a direction (511), which is outside the range from 180° to 90°. Thus, the picture (501) is vertically flipped into a flipped picture (502), and the adjusted orientation of the flipped picture (502) is a direction (512). In the example shown in FIG. 5, a layout of the bridge in FIG. 5 changes an orientation (e.g., the direction (511)) that is from the top-right to the bottom-left to the direction (512) that is from the bottom-right to the top-left. The direction (512) is more aligned with the direction corresponding to the mode number 34 than the direction (511).

In video coding, one or more intermediate coding information buffers (e.g., multiple intermediate coding information buffers) may store intermediate coding information of a picture. The intermediate coding information may include one or more of (i) one or more intra prediction modes in the intra mode coding, (ii) motion vector prediction information in the inter coding, (iii) block vectors in block vector based coding, such as an intra block copy mode, an intra template matching prediction (IntraTMP) mode, and/or the like, (iv) model parameters such as model parameters in a cross-component convolution model and/or the like, (v) a boundary strength for deblocking, and the like. In some examples, the one or more intermediate coding information buffers are maintained for the picture. In an example, each picture stored in a picture buffer, such as a decoded picture buffer (DPB), has the respective one or more intermediate coding information buffers. In some examples, the coding information (e.g., the stored coding information described above) in the one or more intermediate coding information buffers may be inherited by future pictures to be coded, for example, to achieve better coding performance.

When one or more pictures out of a picture set (e.g., a whole picture set) are to be flipped and/or rotated, a codec may maintain a unified orientation (also interchangeably referred to as a unified direction) in the picture buffer (e.g., the DPB). In an aspect, pictures stored in the picture buffer have the same unified orientation. In an aspect, the unified orientation indicates whether the pictures stored in the picture buffer are oriented in (i) the original orientation or (ii) the adjusted orientation. For example, the unified orientation indicates whether the pictures are (i) flipped/rotated or (ii) not flipped/rotated. In an example, the unified orientation is one of (i) the original orientation (e.g., not flipped and not rotated) and (ii) the adjusted orientation (e.g., flipped/rotated).

When the unified orientation is the original orientation, an adjusted picture (e.g., a flipped picture) is to be adjusted back (e.g., flipped back) before the picture is stored (e.g., pushed) in the picture buffer. In some examples, the reconstructed picture has been flipped back after the picture is finished (e.g., is encoded or is decoded) in an encoder or a decoder. Thus, the flipped picture is coded (e.g., encoded or decoded) and then the coded and flipped picture is flipped back to obtain a restored picture. The restored picture is oriented in the original orientation of the picture and is coded (e.g., encoded or decoded).

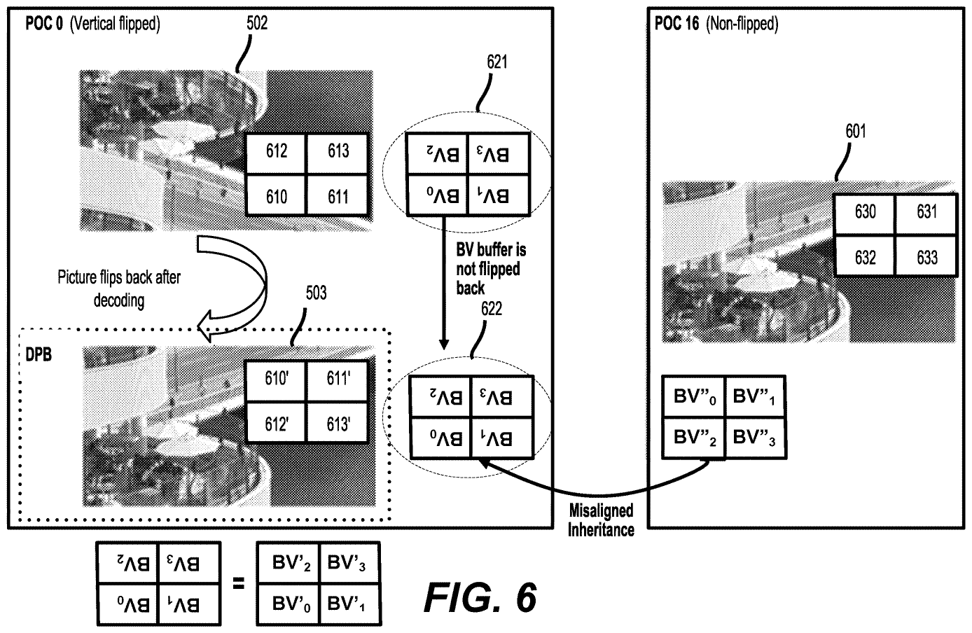

In some examples, the intermediate coding information in the one or more intermediate coding information buffers of the flipped picture is also in the adjusted orientation (e.g., a flipped direction), for example, the intermediate coding information of the flipped picture corresponds to the adjusted orientation. When future pictures whose orientations are not adjusted (e.g., the future pictures are not flipped during the coding process) inherit the intermediate coding information that corresponds to the adjusted orientation, misalignment occurs between the flip and non-flipped pictures during inheritance, such as shown in FIG. 6.

FIG. 6 shows an example of misalignment for the intermediate coding information between a flipped picture (POC 0) and a non-flipped picture (POC 16) according to an aspect of the disclosure. Referring back to FIG. 5, the picture (501) is flipped to obtain the flipped picture (502). In an example, referring to FIG. 6, the flipped picture (502) is coded, such as encoded or decoded. The flipped picture (502) is POC 0 in FIG. 6. In an example, blocks (610)-(613) in the flipped picture (502) are coded using block vectors BV′₀ to BV′₃, respectively. In an example shown in FIG. 6, BV′₀ to BV′₃ are equal to vertically flipped BV₀ to BV₃, respectively where horizontal components of BV′₀ to BV′₃ are equal to horizontal components of BV₀ to BV₃, respectively and vertical components of BV′₀ to BV′₃ are opposite to vertical components of BV₀ to BV₃, respectively.

When the flipped picture (502) is coded, the coded and flipped picture (502) is restored to a restored picture (503) that has the original orientation of the picture (502), for example, by flipping back the coded and flipped picture (502). Referring to FIG. 6, the restored picture (503) is coded and has the original orientation of the picture (502). When the flipped picture (502) is flipped back, the blocks (610)-(613) in the flipped picture (502) are flipped to form blocks (610')-(613') in the restored picture (503), respectively. The restored picture (503) may be stored in the picture buffer such as the DPB.

Referring to FIG. 6, the intermediate coding information buffer (621) of the flipped picture (502) includes block vector information such as BV′₀ to BV′₃ and that BV′₀ to BV′₃ are associated with the blocks (610)-(613), respectively. The intermediate coding information buffer (621) of the flipped picture (502) is aligned with the adjusted orientation. For example, the block (610) associated with BV′₀ is below the block (612) associated with BV′₂. When the flipped picture (502) is restored (e.g., flipped back) to the restored picture (503) and the intermediate coding information buffer (621) is not restored, intermediate coding information (622) associated with the restored picture (503) is the same as the intermediate coding information buffer (621). Referring to FIG. 6, the blocks (610')-(613') in the restored picture (503) are associated with BV′₂, BV′₃, BV′₀, and BV′₁, respectively, and are not associated with BV₀ to BV₃, respectively. Thus, the intermediate coding information (622) associated with the restored picture (503) is misaligned. For example, the positions and values of BV′₀ to BV′₃ are not the same as the positions and values of BV₀ to BV₃, respectively.

In some examples, the picture (601) (e.g., the POC 16) is coded based on the intermediate coding information (622) associated with the restored picture (503). The picture (601) is aligned with the original orientation, and thus blocks (630)-(633) correspond to the blocks (610')-(613') in the restored picture (503), respectively. Accordingly, the intermediate coding information (622) associated with the restored picture (503) is inherited by the picture (601) when the picture (601) is being coded. For example, BV″ to BV″ are associated with the blocks (630)-(633) in the picture (601), respectively. BV″ to BV″ are inherited from the vertically flipped BV₂, BV₃, BV₀, and BV₁, respectively. Thus, BV″ is inherited from the vertically flipped BV₂ instead of BV₀, and thus the inheritance is misaligned.

The above description shows that the relative positions of the blocks associated with the BVs change when the flipped picture (502) is restored to the restored picture (503). In some examples, such as shown in FIG. 6 regarding the block vectors, values of the BVs may also need to be changed (e.g., vertically flipped) when the flipped picture (502) is restored to the restored picture (503).

In an example, BV₂ is a vector having a horizontal component BV₂ₓ and a vertical component BV_{2y}, and BV″ is a vector having a horizontal component BV″ₓ and a vertical component BV″_{y}. BV″ is to be inherited from BV₀ where BV″ₓ=BV₀ₓ and BV″_{y}=BV_{0y}. However, referring to FIG. 6, BV″ is inherited from BV′₂ (i.e., the vertically flipped BV₂), and thus BV″₀ₓ=BV₂ₓ and BV″_{0y}=−BV_{2y}. Thus, the inherited values are incorrect.

In an aspect, an adjusted picture is a picture whose orientation (or direction) is adjusted, and the adjusted orientation is different from the original orientation of the picture. The adjustment includes flipping the picture along one or more axes, rotating the picture by a given angle, a combination of flipping and rotating the picture, and/or the like. In an example, the adjusted picture is a picture flipped along an axis. In an example, the adjusted picture is a picture rotated by a given angle. In an example, the adjusted picture is a picture that is rotated and flipped.

According to an aspect of the disclosure, when an orientation of a picture in a picture set (e.g., a whole picture set) in video coding is adjusted to form an adjusted picture (e.g., the picture is flipped and/or rotated,) coding information buffer(s) (also referred to as intermediate coding information buffer(s) in some examples) of the adjusted picture are modified (e.g., adjusted or adapted), for example, an orientation (or a direction) of the coding information buffer(s) of the adjusted picture is modified (e.g., adjusted or adapted) with a unified direction. In some examples, coding information stored in the coding information buffer(s) of the adjusted picture is used in coding other pictures, and thus reducing redundancy. Adjusting or adapting the coding information buffer(s) of the adjusted picture includes adjusting the orientation of the coding information buffer(s) of the adjusted picture (e.g., aligning the orientation of the coding information buffer(s) of the adjusted picture with the unified orientation), adjusting the coding information stored in the coding information buffer(s) of the adjusted picture, and/or the like.

In an example, the picture set includes a plurality of pictures in a picture buffer.

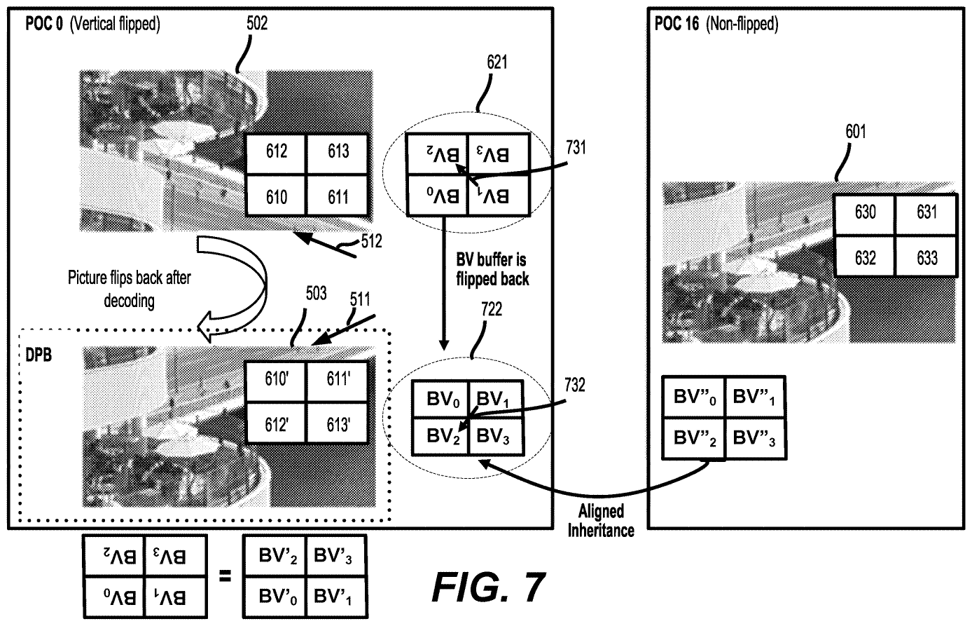

In an aspect, coding information stored in coding information buffer(s) includes block vectors (BVs), and the BVs are adapted to an original orientation (or an original direction) of a picture. FIG. 7 shows an example of an aligned inheritance (or an adapted inheritance) of intermediate coding information for block vector (BV) according to an aspect of the disclosure.

The intermediate coding information buffer of a picture (e.g., a POC 1) storing the BVs is adapted to the original direction of the picture, such that other pictures (e.g., a POC 16) without adjustment of the orientation (e.g., without flipping) inherit the corresponding BVs (e.g., the aligned BVs) of the POC 0 in a decoded picture buffer (DPB). In this case shown in FIG. 7, not only are the locations associated with the BVs flipped, but the values of the BVs are also adapted (e.g., flipped vertically).

Referring to FIG. 7, the flipped picture (502), the intermediate coding information buffer (621) of the flipped picture (502), the blocks (610)-(613) in the flipped picture (502), BV′₀ to BV′₃ associated with the blocks (610)-(613), the restored picture (503), and the blocks (610′)-(613′) in the restored picture (503) in FIG. 7 are described in detail in FIG. 6. In an example shown in FIG. 7, BV′₀ to BV′₃ are equal to vertically flipped BV₀ to BV₃, respectively as described in FIG. 6.

Referring to FIG. 7, the restored picture (503) is coded and has the original orientation of the picture (502). When the flipped picture (502) is flipped back, the blocks (610)-(613) in the flipped picture (502) are flipped to form the blocks (610')-(613′) in the restored picture (503), respectively. In this case as shown in FIG. 7, the intermediate coding information buffer (621) is adapted or adjusted to generate coding information buffer (722) (also referred to as intermediate coding information buffer (722) in some examples) of the restored picture (503).

The coding information buffer (722) includes block vector information such as BV₀ to BV₃ and that BV₀ to BV₃ are associated with the blocks (610')-(613'), respectively. The coding information buffer (722) of the restored picture (503) is aligned with the original orientation. For example, the block (610′) associated with BV₀ is above the block (612′) associated with BV₂. When the flipped picture (502) is restored (e.g., flipped back) to the restored picture (503), the coding information buffer (621) is restored to the coding information buffer (722). Referring to FIG. 7, the blocks (610')-(613′) in the restored picture (503) are associated with BV₀ to BV₃ in the coding information buffer (722), respectively. Thus, the coding information buffer (722) associated with the restored picture (503) is aligned with the restored picture (503).

Referring to FIG. 7, the adjustment of the coding information buffer (722) includes adjustments of the positions (e.g., the positions of the blocks) associated with the BVs and adjustments of the values of the BVs. For example, BV′₀ is associated with the block (610), and BV′₂ is associated with the block (612). After adjusting the block (610) to obtain the block (610′), BV′₀ is adjusted to become BV₀. In an example, BV₀ is a vector having a horizontal component BV₀ₓ and a vertical component BV_{0y}, and BV′₀ is a vector having a horizontal component BV′₀ₓ and a vertical component BV′_{0y}. For example, BV′₀ is vertically flipped to become BV₀ where BV₀ₓ=BV′₀ₓ and BV_{0y}=−BV′_{0y}. The same applies to BV′₁ to BV′₃. In an example, BV₁ indicated by an arrow (732) is a vector having a horizontal component BV₁ₓ and a vertical component BV_{1y}, and BV′₁ indicated by an arrow (731) is a vector having a horizontal component BV′₁ₓ and a vertical component BV′_{1y}. For example, BV′₁ is vertically flipped to become BV₁ where BV₁ₓ=BV′₁ₓ and BV_{1y}=−BV′_{1y}.

In some examples, the coding information buffer (722) is used by other pictures, such as the POC 16 that is not flipped and is in the original orientation.

In an aspect, the adjusted picture (502) is obtained by adjusting the POC 0. The flipped picture (502) is then encoded or decoded. The coded picture (502) is then adjusted (e.g., flipped back) and stored in the DPB. Further, the intermediate coding information buffer (621) is adjusted (e.g., flipped). The adjusted (e.g., flipped-back) intermediate coding information buffer (722) is then used for other pictures (e.g., the POC 16 that is not flipped). The unified intermediate coding information stored in the intermediate coding information buffer (722) associated with the restored picture (503) is inherited by the picture (601) when the picture (601) is being coded. In an example, the picture (601) is the non-flipped POC 16. For example, BV″ to BV″ are associated with the blocks (630)-(633) in the picture (601), respectively. BV″ to BV″ are inherited from BV₀ to BV₃, respectively. Thus, BV″ is inherited from BV₀, and thus the inheritance is aligned.

In an example, an output of the encoded or decoded picture is a flipped-back picture such as the picture (503) and the picture (503) is used for display purposes. Regarding transmission in the bitstream, the picture may be transmitted in the flipped form (e.g., the picture (502)) or in the flipped-back form (e.g., the picture (503)). In some examples, high-level syntax controls the information indicating whether the picture is flipped or not in transmission.

In an aspect, referring to FIG. 5, the orientation of the picture (e.g., (501)) is adjusted from the original orientation (e.g., (511)) to the adjusted orientation (e.g., (512)), for example, by vertically flipping the picture (501) to the picture (502). Referring to FIGS. 5 and 7, the adjusted picture (502) in the adjusted orientation (512) is coded (e.g., encoded or decoded). Unified intermediate coding information of the picture is generated based on the unified orientation of the plurality of pictures in the picture buffer (e.g., the DPB). The unified orientation is one of (i) the original orientation (511) and (ii) the adjusted orientation (512). The plurality of pictures in the picture buffer is oriented in the unified orientation. The unified intermediate coding information is stored in one or more intermediate coding information buffers (e.g., (722)) associated with the picture (503). In an example shown in FIG. 7, the unified intermediate coding information is stored in the intermediate coding information buffer (722).

The plurality of pictures in the picture buffer includes the picture (503). One or more other pictures are encoded based on the unified intermediate coding information of the picture.

In an example shown in FIG. 7, the unified orientation is the original orientation (511). The picture is reconstructed based on the encoded picture in the adjusted orientation (512). The reconstructed picture (502) in the adjusted orientation (512) is then restored to the original orientation (511). The restored picture (503) in the original orientation (511) is stored in the picture buffer (e.g., the DPB). The unified intermediate coding information of the picture is generated based on the unified orientation being the original orientation (511). For example, the unified intermediate coding information of the picture is generated in the original orientation (511). The unified intermediate coding information includes BV₀ to BV₃ associated with the blocks (610′)-(613′), respectively.

In an aspect, the orientation adjustment includes a vertical flip of the picture (501) to generate the flipped picture (502) as shown in FIG. 5. Intermediate coding information of the picture (502) that is flipped and reconstructed in the one or more intermediate coding information buffers includes a first BV and a second BV. Referring to FIG. 7, the first BV (BV′₀) is associated with the first block (610) in the flipped picture (502) in the adjusted orientation (512) and includes the horizontal component BV′₀ₓ and the vertical component BV′_{0y}. The second BV (BV′₂) is associated with the second block (612) in the flipped picture (502) in the adjusted orientation (512) and includes the horizontal component BV′₂ₓ and the vertical component BV′_{2y}. The second block (612) is above the first block (610) in the flipped picture (502) in the adjusted orientation (512).

The unified intermediate coding information is generated by flipping the first BV and the second BV into the flipped first BV and the flipped second BV. The flipped first BV (BV₀) includes the horizontal component BV₀ₓ and the vertical component BV_{0y}, and the flipped second BV (BV₂) includes the horizontal component BV₂ₓ and the vertical component BV_{2y}. The first block (610) associated with the first BV in the flipped picture (502) is flipped to the first block (610′) associated with the flipped first BV in the restored picture (503), and the second block (612) associated with the second BV in the flipped picture (502) is flipped to the second block (612′) associated with the flipped second BV in the restored picture (503). BV₀ₓ=BV′₀ₓ, BV_{0y}=−BV′0y, BV₂ₓ=BV′₂ₓ, and BV_{2y}=−BV′_{2y}. The unified intermediate coding information indicates the flipped first BV, the flipped second BV, and that the first block (610′) associated with the flipped first BV (BV₀) is above the second block (612′) associated with the flipped second BV (BV₂) in the restored picture (503).

In an aspect, a CU or a coding block is predicted using a prediction mode based on model parameters, such as model parameters of a cross-component convolution model. The model parameters are derived based on reconstructed samples of a current CU (e.g., a current template of the current CU). When adjusting (e.g., flipping back) a coding information buffer (e.g., an intermediate coding information buffer) including the model parameters, the model parameters are inherited by other pictures that are not adjusted (e.g., not flipped). In this case, the model parameters are to be re-derived based on the adjusted or the updated (e.g., flipped-back) reconstructed samples.

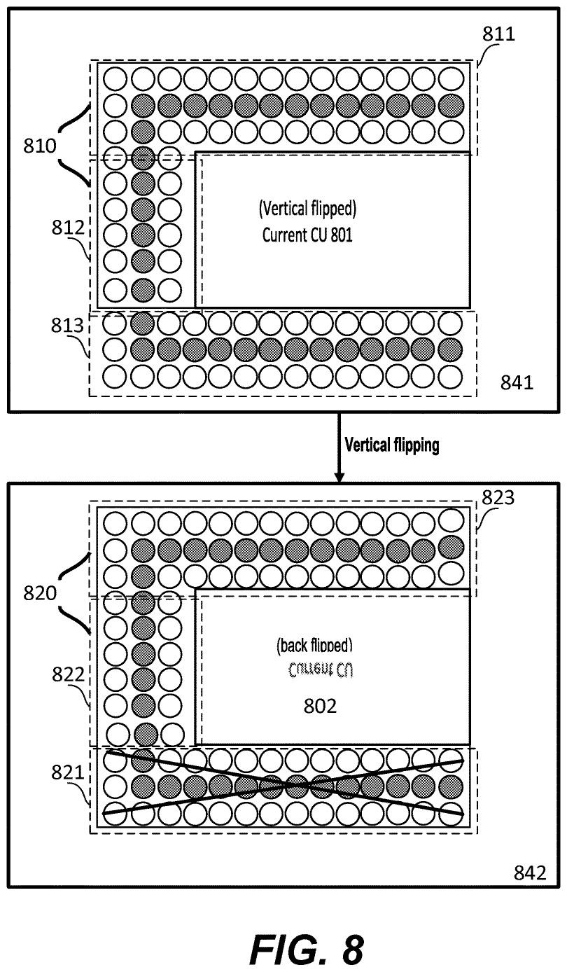

FIG. 8 shows an example when the model parameters are derived from a template (e.g., a top-left template having a template size equal to 3 lines of reconstructed samples). When the reconstructed picture is adjusted (e.g., flipped back), the template of the reconstructed picture is updated and the model parameters are re-derived. Referring to FIG. 8, a current picture (841) is adjusted (e.g., vertically flipped) from a picture and includes a current CU (801) that is adjusted from a current CU in the picture. In an example, the current CU (801) is also referred to as a flipped block (801) as the current CU (801) is generated by flipping a block in the picture. A current template (810) of the current CU (801) includes a top template (811) and a left template (812). In some examples, the model parameters used to predict the current CU (801) are derived from the current template (810). When the picture (841) is reconstructed and adjusted back to generate a restored picture (842), the current CU (801) is adjusted to generate an adjusted current CU (e.g., a back-flipped CU shown in FIG. 8) (802), the top template (811) is adjusted to generate a template (821), the left template (812) is adjusted to generate a template (822), and an area (813) is adjusted to generate a template (823). The adjusted current CU (802) is also referred to as a restored block. The area (813) includes neighboring reconstructed samples that are below and to the left of the current CU (801). In the example shown in FIG. 8, the template (821) is generated by vertically flipping the template (811), the template (822) is generated by vertically flipping the template (812), and the template (823) is generated by vertically flipping the area (813). In the restored picture (842), the current template of the adjusted current CU (802) is the current template (820) including the templates (822)-(823). The model parameters of the restored picture (842) are derived from the current template (820), and the model parameters of the restored picture (842) are used for other pictures.

In an example, the orientation adjustment includes a vertical flip of the picture (501) to generate the flipped picture (502) as shown in FIG. 5. In an example, the flipped picture (502) is the picture (841) in FIG. 8. Referring to FIG. 8, first model parameters of the flipped block (801) in the flipped picture (841) are derived based on the template (810) of the flipped block (801) in the flipped picture (841). Referring to FIGS. 5 and 8, the flipped block (801) is a vertical flip of a corresponding block in the picture (501) in the original orientation (511). The template (810) in the flipped picture (841) includes neighboring reconstructed samples in the flipped picture (841) that are above the flipped block (801) and/or to the left of the flipped block (801) in the flipped picture (841). The flipped block in the flipped picture is encoded based on the first model parameters. The reconstructed and flipped picture (841) is flipped vertically to obtain the restored picture (842) in the original orientation (e.g., (511)). The restored picture (842) includes a restored block (802) that is a vertical flip of the flipped block (801) that is reconstructed. Second model parameters of the restored block (802) in the restored picture (842) are derived based on a template (820) of the restored block (802) in the restored picture (842). The template (820) in the restored picture (842) includes neighboring reconstructed samples in the restored picture (842) that are above the restored block (802) and/or to the left of the restored block (802) in the restored picture (842). The unified intermediate coding information of the picture in the one or more intermediate coding information buffers includes the second model parameters of the restored block (802) in the restored picture (842).

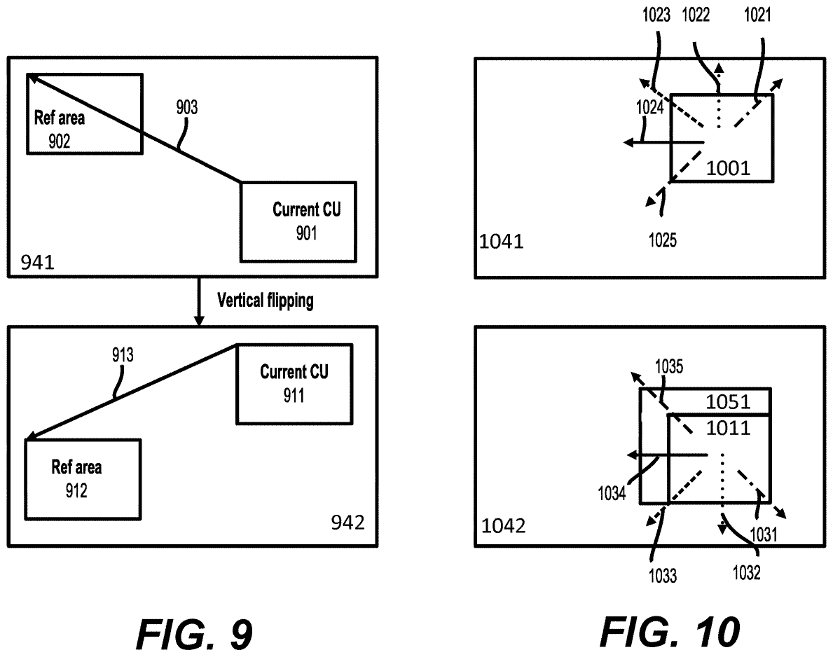

In an aspect, a CU or a coding block is predicted using a prediction mode based on model parameters. The model parameters are derived based on reconstructed samples indicated by a BV, as shown in FIG. 9. When adjusting (e.g., flipping back) a coding information buffer (e.g., an intermediate coding information buffer) including the model parameters, the model parameters are to be re-derived based on the adjusted or the updated (e.g., flipped-back) reconstructed samples pointed by an adjusted BV (e.g., a back-flipped BV). In some examples, an adaptation is a combination of the methods described in FIGS. 7-8 and is shown in FIG. 9.

FIG. 9 shows an example of model parameters that rely on the samples from the reconstructed area indicated by a BV according to an aspect of the disclosure. A current CU (901) is located in an adjusted picture (941) (e.g., a vertically flipped picture). In an example, the adjusted picture (941)is reconstructed. The model parameters of the current CU (901) are derived based on a reference area (902) indicated by a BV (903) of the current CU (901). The reference area (902) is in the picture (941).

When the reconstructed picture (941) is adjusted (e.g., flipped back such as vertically flipped) to generate a restored picture (942), the current CU (901) is adjusted (e.g., flipped back) to generate a current CU (911) in the restored picture (942). Further, the reference area (902) is vertically flipped to generate a reference area (912) in the restored picture (942). The BV (903) is vertically flipped to generate a BV (913). The BV (913) is associated with the current CU (911) and indicates the reference area (912). The model parameters associated with the current CU (911) are re-derived based on the reference area (912) that includes the adjusted (e.g., flipped-back) reconstructed samples pointed by the BV (913).

In the example, the orientation adjustment includes the vertical flip of the picture such as shown in FIG. 5. First model parameters of the flipped block (901) in the flipped picture (941) are derived based on the reference area (902) in the flipped picture (941) that is indicated by the block vector (BV) (903) pointing from the flipped block (901) to the reference area (902). The BV (903) includes the horizontal component BVₓ and the vertical component BV_{y}. The flipped block (901) is the vertical flip of a corresponding block in the picture (e.g., (501)) in the original orientation (e.g., (511)). The flipped block (901) in the flipped picture (941) is coded (e.g., encoded or decoded) based on the first model parameters. The reconstructed and flipped picture (941) is flipped vertically to obtain the restored picture (942) in the original orientation (511). The restored picture (942) includes the restored block (911) that is the vertical flip of the flipped block (901) that is reconstructed. The BV (903) is flipped into the flipped BV (913). The flipped BV (913) includes the horizontal component BV′ₓ that is equal to BVₓ and the vertical component BV′_{y} that is opposite to BV_{y}. The flipped BV (913) points from the restored block (911) to the reference area (912) in the restored picture (942). Second model parameters of the restored block (911) in the restored picture (942) are derived based on the reference area (912) in the restored picture (942) indicated by the flipped BV (913). The unified intermediate coding information of the picture in the one or more intermediate coding information buffers includes the second model parameters of the restored block (911) in the restored picture (942).

In an aspect, a CU or a coding block is predicted using an intra prediction mode (IPM). When adjusting (e.g., flipping back) a coding information buffer (e.g., an intermediate coding information buffer) including the IPM, the IPM is to be re-derived based on the adjusted orientation or the adjusted direction such as shown in FIG. 10. FIG. 10 shows an example of updating (e.g., remapping) the IPM when back-flipping the coding information buffer (also referred to as the IPM buffer in some examples) that stores the IPM. In some examples, the adjusted direction is referred to as a flipping direction. For example, a current CU (1001) is in an adjusted picture (1041) (e.g., a vertically flipped picture). In an example, the adjusted picture (1041) is reconstructed. An IPM (e.g., one of IPMs (1021)-(1025)) is associated with the current CU (1001). For example, the current CU (1001) is derived using the IPM. In an example, the adjusted direction refers to a flipping direction such as a vertical direction, a horizontal direction, or the like when the adjustment is a flipping operation. In an example, the adjusted direction refers to an angle that a picture is rotated to generate the adjusted picture (1041). Referring to FIG. 10, the adjusted direction is a vertical direction, and the picture is vertically flipped to generate the flipped picture (1041) and the flipped picture (1041) is coded, for example, the current CU (1001) is predicted using the IPM (e.g., the IPM (1021)). When the reconstructed and flipped picture (1041) is restored (e.g., flipped back vertically) to the original orientation to generate a restored picture (1042), the current CU (1001) is flipped back to generate a current CU (1011).

FIG. 10 shows a remapping example for the vertical flipping. IPMs correspond to prediction directions, respectively. In an example, a relationship between IPMs and prediction directions is described in FIG. 4. Referring to FIGS. 4 and 10, the IPM (1021) is the mode 66 and corresponds to a prediction direction of 45°, the IPM (1022) is the mode 50 and corresponds to a prediction direction of 90°, the IPM (1023) is the mode 34 and corresponds to a prediction direction of 135°, the IPM (1024) is the mode 18 and corresponds to a prediction direction of 180°, and the IPM (1025) is the mode 2 and corresponds to a prediction direction of −135°.

In an example, the orientation adjustment includes a vertical flip of the picture such as shown in FIG. 5. The flipped block (1001) in the flipped picture (1041) is coded (e.g., encoded or decoded) based on a first IPM (e.g., (1023)). The reconstructed and flipped picture (1041) is flipped vertically to obtain the restored picture (1042) in the original orientation (511). The restored picture (1042) includes the restored block (1011) that is a vertical flip of the flipped block (1001) that is reconstructed. The first IPM (1023) of the flipped block (1001) is remapped into a second IPM (1033) based on the adjusted orientation of the picture being the vertical flip. The unified intermediate coding information of the picture in the one or more intermediate coding information buffers includes the second IPM (1033).

In an example, the first IPM is a first angular IPM corresponding to a first direction (e.g., 135° with respect to the x axis). The second IPM is a second angular IPM corresponding to a second direction (e.g., −135° with respect to the x axis). The second direction is a vertical flip of the first direction as shown in FIG. 10.

In an example, the coding information buffer of the picture (1041) is referred to as the vertically flipped buffer, if the IPM stored in the vertically flipped buffer is the mode 34 (e.g., the IPM is the IPM (1023)), the IPM (1023) is remapped to generate an IPM (1033) when the picture (1041) is restored to generate the restored picture (1042). The IPM (1033) is associated with the current CU (1011). After remapping (e.g., back-flipping in the example shown in FIG. 10), the corresponding mode for the IPM (1033) becomes the mode 2 in the back-flipped buffer. The back-flipped buffer is associated with the restored picture (1042) and includes IPMs (1031)-(1035) that are generated by flipping the IPMs (1021)-(1025) stored in the vertically flipped buffer associated with the picture (1041). The back-flipped buffer associated with the restored picture (1042) is generated from the vertically flipped buffer associated with the picture (1041).

In an example, instead of performing a remapping based on the pre-defined IPM relation to the prediction directions such as the relationship shown in FIG. 4, a decoder side mode derivation (DIMD) is applied on the corresponding reconstructed block samples to derive a new intra mode (e.g., a new IPM). Referring back to FIG. 10, after back-flipping to generate the CU (1011), the DIMD is applied to the template (1051) to derive a new IPM as the new IPM associated with the CU (1011).

In an example, the remapping of the first IPM includes deriving, using the DIMD, the second IPM of the restored block (1011) in the restored picture (1042) based on a template (1051) of the restored block (1011) in the restored picture (1042). The template (1051) in the restored picture includes neighboring reconstructed samples in the restored picture that are above the restored block and/or to the left of the restored block (1011) in the restored picture (1042).

In an aspect, only intra picture (or an I-picture) without motion compensation across temporal pictures is allowed to be applied with an adjusting operation. For example, a P picture or a B picture is not allowed to flip. In an example, the picture is restricted to be an intra picture (I picture).

In an aspect, the adjusting operation includes a flipping operation, a rotation operation, a combination of a flipping operation and a rotation operation, or the like. For example, the flipping direction includes a vertical direction, a horizontal direction, a N×90° rotation (e.g., 90° rotation, −90° rotation, or the like), or their combinations. N is an integer that is not zero. In an example, the adjusting the orientation includes one or more of: flipping the first picture vertically where the adjusted orientation of the first picture is a vertical flip; flipping the first picture horizontally where the adjusted orientation of the first picture is a horizontal flip; and rotating the first picture N×90° where the adjusted orientation of the first picture is a rotation of N×90°.

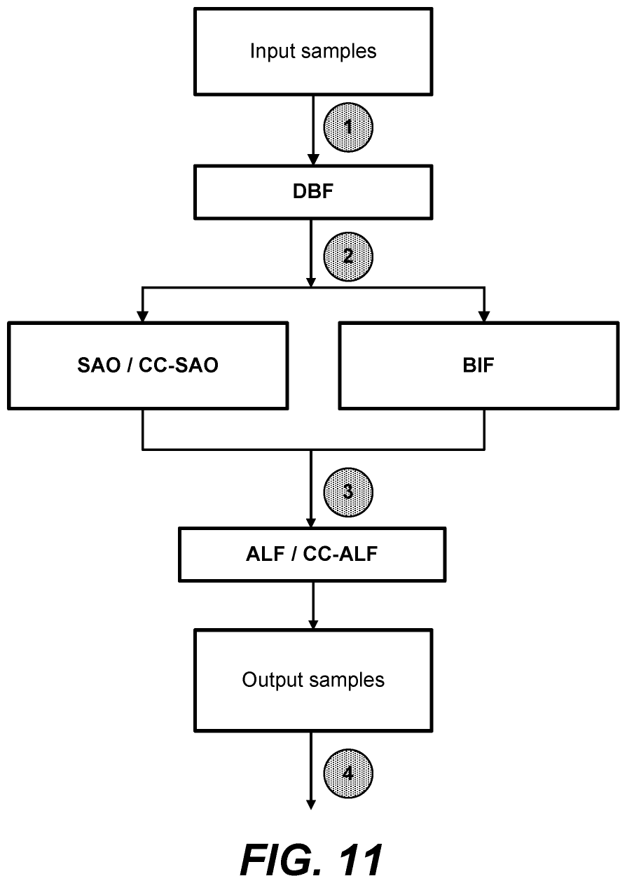

In an aspect, when an adjusted picture is coded (e.g., encoded or decoded), a back adjustment (e.g., a back-flip) is applied to the coded and adjusted picture (or the reconstructed and adjusted picture) before one or more in-loop filters. Compared to the coding information buffers described in FIGS. 7-10, the intermediate coding information buffer used for the in-loop filter after this back-flipping does not need to perform back-flipping. FIG. 11 shows examples of positions for a back-flipping operation in the in-loop filters according to an aspect of the disclosure. Referring to FIG. 11, an in-loop filter pipeline in a modern codec is shown.

Referring to FIG. 11, input samples include reconstructed samples in the flipped picture.

In an aspect, the back-flipping of the reconstructed picture (e.g., the reconstructed picture is the flipped picture that is reconstructed) is applied at a position 1 before a deblocking filter (DBF). In this case, the intermediate coding information buffer after the position 1 does not need to perform a back-flipping, as these filters have been applied without flipping.

In an aspect, the back-flipping of the reconstructed picture is applied at a position 2 after the DBF. In this case, the DBF is performed at the flipped domain and may benefit from a codec support advanced rate distortion optimization including the DBF stage.

In an aspect, the back-flipping of the reconstructed picture is applied at a position 3 before an adaptive loop filter (ALF)/cross component (CC)-ALF. In this case, compared to the methods described in FIGS. 7-10, the learned ALF coefficients do not need back-flipping before writing the ALF coefficients to the bitstream.

Referring to FIG. 11, in some examples, the reconstructed samples that are deblock filtered are input to a Sample Adaptive Offset (SAO) or CC-SAO. In some examples, the reconstructed samples that are deblock filtered are input to a bilateral interpolation filter (BIF).

Referring back to FIGS. 7-10, the back-flip of the reconstructed and flipped picture, e.g., the back-flip of the picture (502), the picture (841), the picture (941), or the picture (1041), is applied after output samples are generated. Thus, referring to FIG. 11, the back-flip of the reconstructed and flipped picture described in FIGS. 7-10 is performed at a position 4.

In various examples, without loss of generality, other intermediate coding information buffers that may be inherited by other pictures are adapted to the unified direction.

In various examples, without loss of generality, the unified direction may be the flipped direction instead of the original direction. In this case, the back-flipping for the flipped picture does not need to be performed. Instead, a flipping of the non-flipped picture is performed in some examples.

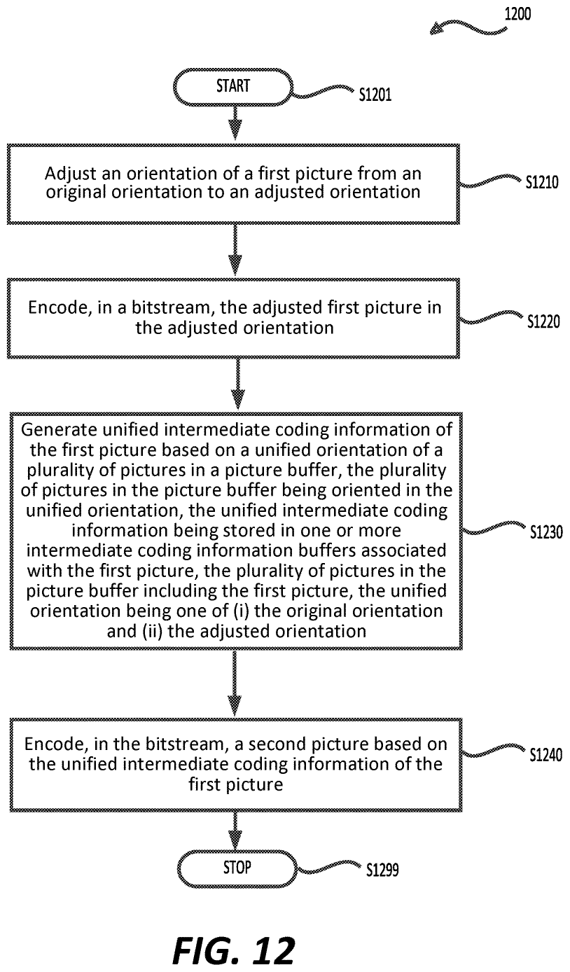

FIG. 12 shows a flow chart outlining a process (1200) according to an aspect of the disclosure. The process (1200) may be used in an apparatus, such as a video encoder. In various aspects, the process (1200) is executed by processing circuitry, such as the processing circuitry that performs functions of the video encoder (103), the processing circuitry that performs functions of the video encoder (303), and/or the like. In some aspects, the process (1200) is implemented in software instructions, thus when the processing circuitry executes the software instructions, the processing circuitry performs the process (1200). The process starts at (S1201) and proceeds to (S1210).

At (S1210), an orientation of a first picture is adjusted from an original orientation to an adjusted orientation.

At (S1220), the adjusted first picture is encoded in the adjusted orientation in a bitstream.

At (S1230), unified intermediate coding information of the first picture is generated based on a unified orientation of a plurality of pictures in a picture buffer. The plurality of pictures in the picture buffer is oriented in the unified orientation. The unified intermediate coding information is stored in one or more intermediate coding information buffers associated with the first picture. The plurality of pictures in the picture buffer includes the first picture. The unified orientation is one of (i) the original orientation and (ii) the adjusted orientation.

At (S1240), a second picture is encoded in the bitstream based on the unified intermediate coding information of the first picture.

Then, the process proceeds to (S1299) and terminates.

The process (1200) may be suitably adapted. Step(s) in the process (1200) may be modified and/or omitted. Additional step(s) may be added. Any suitable order of implementation may be used.

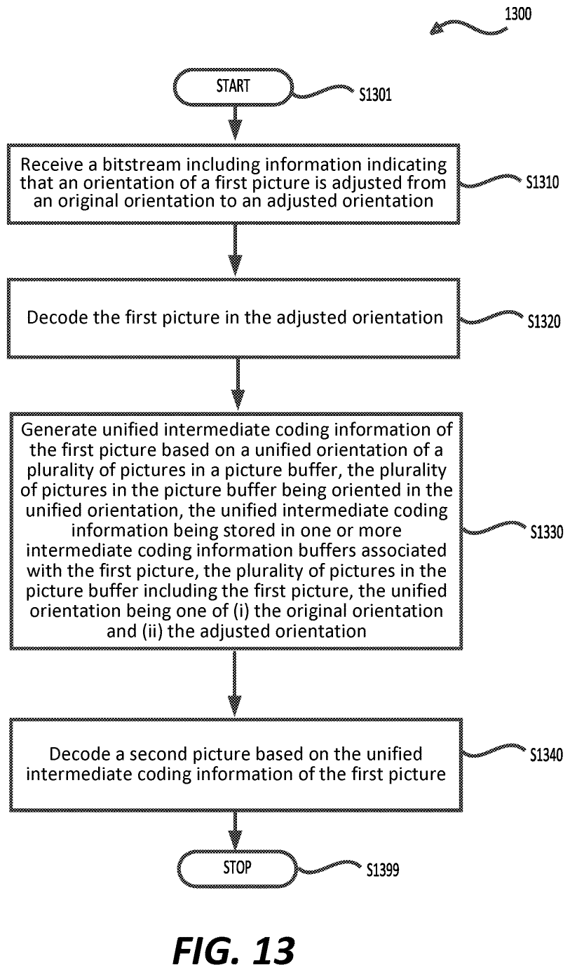

FIG. 13 shows a flow chart outlining a process (1300) according to an aspect of the disclosure. The process (1300) may be used in an apparatus, such as a video decoder. In various aspects, the process (1300) is executed by processing circuitry, such as the processing circuitry that performs functions of the video decoder (110), the processing circuitry that performs functions of the video decoder (210), and the like. In some aspects, the process (1300) is implemented in software instructions, thus when the processing circuitry executes the software instructions, the processing circuitry performs the process (1300). The process starts at (S1301) and proceeds to (S1310).

At (S1310), a bitstream including information indicating that an orientation of a first picture is adjusted from an original orientation to an adjusted orientation is received.

At (S1320), the first picture in the adjusted orientation is decoded.

At (S1330), unified intermediate coding information of the first picture is generated based on a unified orientation of a plurality of pictures in a picture buffer. The plurality of pictures in the picture buffer is oriented in the unified orientation. The unified intermediate coding information is stored in one or more intermediate coding information buffers associated with the first picture. The plurality of pictures in the picture buffer includes the first picture. The unified orientation is one of (i) the original orientation and (ii) the adjusted orientation.

At (S1340), a second picture is decoded based on the unified intermediate coding information of the first picture.

Then, the process proceeds to (S1399) and terminates.

The process (1300) may be suitably adapted. Step(s) in the process (1300) may be modified and/or omitted. Additional step(s) may be added. Any suitable order of implementation may be used.

In an aspect, a non-transitory computer-readable storage medium storing instructions which when executed by a processor cause the processor to perform a method of encoding a bitstream. The method includes: adjusting an orientation of a first picture from an original orientation to an adjusted orientation; encoding, in the bitstream, the adjusted first picture in the adjusted orientation; generating unified intermediate coding information of the first picture based on a unified orientation of a plurality of pictures in a picture buffer; encoding, in the bitstream, a second picture based on the unified intermediate coding information of the first picture. The plurality of pictures in the picture buffer is oriented in the unified orientation. The unified intermediate coding information is stored in one or more intermediate coding information buffers associated with the first picture. The plurality of pictures in the picture buffer includes the first picture. The unified orientation is one of (i) the original orientation and (ii) the adjusted orientation. In an example, the bitstream is transmitted.

An aspect of the disclosure provides methods, apparatuses, and non-transitory storage medium for video encoding and decoding that adapt intermediate coding information when a picture is coded in a flipped or rotated direction. In video coding, multiple intermediate coding information buffers store intermediate coding information including, for example, intra prediction modes, block vectors, model parameters, and the like are maintained for a picture so that the intermediate coding information in these buffers is inherited by future pictures to achieve better coding performance. When one or more pictures out of a whole picture set are flipped to improve coding performance by aligning the picture layout with a certain direction, a codec maintains a unified orientation in a picture buffer. When the unified orientation is the original orientation, a flipped picture is flipped back before the flipped picture is stored in the picture buffer. However, in related technologies, the intermediate coding information buffers of the flipped picture are left in a flipped direction. When future pictures without flipping inherit the coding information, misalignment occurs during the inheritance between flipped and non-flipped pictures. According to some aspects of the disclosure, the intermediate coding information buffers are adapted to a unified direction when one or more pictures are flipped among the whole picture set, and thus addressing the misalignment issue and enabling aligned inheritance of the coding information across pictures with different orientations.

Compared to related technologies that do not adapt the intermediate coding information after flipping, the disclosed methods result in correctly aligned intermediate coding information buffers that ensure consistent inheritance across flipped and non-flipped pictures. The adaptation includes flipping block vectors along with their associated block positions, re-deriving model parameters based on updated reconstructed samples in the restored picture, and remapping intra prediction modes based on the flip direction. These adaptations are performed during the generation of the unified intermediate coding information, and thus the overhead is incurred once per picture rather than per prediction operation in future pictures. Accordingly, the disclosed methods improve inter-picture coding performance by enabling future pictures to inherit correctly oriented coding information, resulting in better rate-distortion performance with minimal additional computation.

Methods, aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

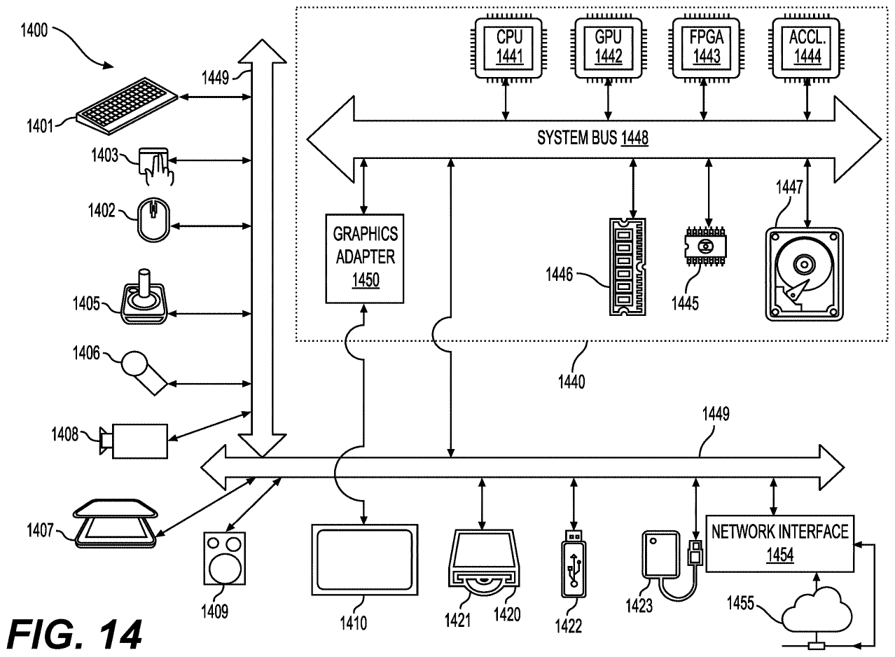

The techniques described above, may be implemented as computer software using computer-readable instructions and physically stored in one or more computer-readable media. For example, FIG. 14 shows a computer system (1400) suitable for implementing certain aspects of the disclosed subject matter.

The computer software may be coded using any suitable machine code or computer language, that may be subject to assembly, compilation, linking, or like mechanisms to create code comprising instructions that may be executed directly, or through interpretation, micro-code execution, and the like, by one or more computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 14 for computer system (1400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there may also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1400) may also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) may also include an interface (1454) to one or more communication networks (1455). Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) may communicate with other entities. Such communication may be uni-directional, receive only (for example, broadcast TV), uni-directional send-only (for example CANbus to certain CANbus devices), or bi-directional, for example to other computer systems using local or wide area digital networks. Certain protocols and protocol stacks may be used on each of those networks and network interfaces as described above.

Aforementioned human interface devices, human-accessible storage devices, and network interfaces may be attached to a core (1440) of the computer system (1400).

The core (1440) may include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) may be accessible in the form of one or more physical plugs to enable extensions by additional CPUs, GPU, and the like. The peripheral devices may be attached either directly to the core's system bus (1448), or through a peripheral bus (1449). In an example, the screen (1410) may be connected to the graphics adapter (1450). Architectures for a peripheral bus include PCI, USB, and the like.

CPUs (1441), GPUs (1442), FPGAs (1443), and accelerators (1444) may execute certain instructions that, in combination, may make up the aforementioned computer code. That computer code may be stored in ROM (1445) or RAM (1446). Transitional data may also be stored in RAM (1446), whereas permanent data may be stored for example, in the internal mass storage (1447). Fast storage and retrieve to any of the memory devices may be enabled through the use of cache memory, that may be closely associated with one or more CPU (1441), GPU (1442), mass storage (1447), ROM (1445), RAM (1446), and the like.

The computer readable media may have computer code thereon for performing various computer-implemented operations. The media and computer code may be those specially designed and constructed for the purposes of the present disclosure, or they may be of the kind well known and available to those skilled in the computer software arts.

As an example and not by way of limitation, the computer system having architecture (1400), and specifically the core (1440) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (1440) that are of non-transitory nature, such as core-internal mass storage (1447) or ROM (1445). The software implementing various aspects of the present disclosure may be stored in such devices and executed by core (1440). A computer-readable medium may include one or more memory devices or chips, according to particular needs. The software may cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system may provide functionality as a result of logic hardwired or otherwise embodied in a circuit (for example: accelerator (1444)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method for video encoding, the method including: adjusting an orientation of a first picture from an original orientation to an adjusted orientation; encoding, in a bitstream, the adjusted first picture in the adjusted orientation; generating unified intermediate coding information of the first picture based on a unified orientation of a plurality of pictures in a picture buffer, the plurality of pictures in the picture buffer being oriented in the unified orientation, the unified intermediate coding information being stored in one or more intermediate coding information buffers associated with the first picture, the plurality of pictures in the picture buffer including the first picture, the unified orientation being one of (i) the original orientation and (ii) the adjusted orientation; and encoding, in the bitstream, a second picture based on the unified intermediate coding information of the first picture.

(2) The method of feature (1), in which the adjusting the orientation includes one or more of: flipping the first picture vertically, the adjusted orientation of the first picture being a vertical flip; flipping the first picture horizontally, the adjusted orientation of the first picture being a horizontal flip; and rotating the first picture N×90°, the adjusted orientation of the first picture being a rotation of N×90°, N being an integer that is not zero.

(3) The method of feature (1) or (2), in which the unified orientation is the original orientation; the method includes: reconstructing the first picture based on the encoded first picture in the adjusted orientation; restoring the reconstructed first picture in the adjusted orientation to the original orientation; and storing the restored first picture that is reconstructed and is in the original orientation in the picture buffer; and the generating includes generating the unified intermediate coding information of the first picture in the original orientation.

(4) The method of feature (3), in which the adjusting the orientation includes a vertical flip of the first picture; intermediate coding information of the first picture in the one or more intermediate coding information buffers includes a first block vector (BV) and a second BV; the first BV is associated with a first block in the flipped first picture in the adjusted orientation and includes a horizontal component BV′₀ₓ and a vertical component BV′_{0y}, the second BV is associated with a second block in the flipped first picture in the adjusted orientation and includes a horizontal component BV′₂ₓ and a vertical component BV′_{2y}, the second block is above the first block in the flipped first picture in the adjusted orientation; and the generating the unified intermediate coding information includes: flipping the first BV and the second BV into the flipped first BV and the flipped second BV, the flipped first BV including a horizontal component BV₀ₓ and a vertical component BV_{0y}, the flipped second BV including a horizontal component BV₂ₓ and a vertical component BV_{2y}, the first block associated with the first BV in the flipped first picture being flipped to a first block associated with the flipped first BV in the restored first picture, the second block associated with the second BV in the flipped first picture being flipped to a second block associated with the flipped second BV in the restored first picture, BV₀ₓ=BV′₀ₓ, BV_{0y}=−BV′_{0y}, BV₂ₓ=BV′₂ₓ, and BV_{2y}=−BV′_{2y}, and the unified intermediate coding information indicates the flipped first BV, the flipped second BV, and the first block associated with the flipped first BV being above the second block associated with the flipped second BV in the restored first picture.

(5) The method of feature (3), in which the adjusting the orientation includes a vertical flip of the first picture; the encoding the first picture includes: deriving first model parameters of a flipped block in the flipped first picture based on a template of the flipped block in the flipped first picture, the flipped block being a vertical flip of a corresponding block in the first picture in the original orientation; the template in the flipped first picture including neighboring reconstructed samples in the flipped first picture that are (i) above the flipped block and/or (ii) to the left of the flipped block in the flipped first picture; encoding the flipped block in the flipped first picture based on the first model parameters; the restoring includes flipping vertically the reconstructed and flipped first picture to obtain a restored first picture in the original orientation, the restored first picture including a restored block that is a vertical flip of the flipped block that is reconstructed; and the generating the unified intermediate coding information includes: deriving second model parameters of the restored block in the restored first picture based on a template of the restored block in the restored first picture, the template in the restored first picture including neighboring reconstructed samples in the restored first picture that are (i) above the restored block and/or (ii) to the left of the restored block in the restored first picture, the unified intermediate coding information of the first picture in the one or more intermediate coding information buffers including the second model parameters of the restored block in the restored first picture.

(6) The method of feature (3), in which the adjusting the orientation includes a vertical flip of the first picture; the encoding the first picture includes: deriving first model parameters of a flipped block in the flipped first picture based on a reference area in the flipped first picture that is indicated by a block vector (BV) pointing from the flipped block to the reference area of the flipped block, the flipped BV including a horizontal component BVx and a vertical component BVy, the flipped block being a vertical flip of a corresponding block in the first picture in the original orientation; and encoding the flipped block in the flipped first picture based on the first model parameters; the restoring includes flipping vertically the reconstructed and flipped first picture to obtain a restored first picture in the original orientation, the restored first picture including a restored block that is a vertical flip of the flipped block that is reconstructed; and the generating the unified intermediate coding information includes: flipping the BV into a flipped BV, the flipped BV including a horizontal component BV′x that is equal to BVx and a vertical component BV′y that is opposite to BVy, the flipped BV pointing from the restored block to a reference area in the restored first picture; deriving second model parameters of the restored block in the restored first picture based on the reference area in the restored first picture indicated by the flipped BV, the unified intermediate coding information of the first picture in the one or more intermediate coding information buffers including the second model parameters of the restored block in the restored first picture.

(7) The method of feature (3), in which the adjusting the orientation includes a vertical flip of the first picture; the encoding the first picture includes encoding a flipped block in the flipped first picture based on a first intra prediction mode; the restoring includes flipping vertically the reconstructed and flipped first picture to obtain a restored first picture in the original orientation, the restored first picture including a restored block that is a vertical flip of the flipped block that is reconstructed; and the generating the unified intermediate coding information includes remapping the first intra prediction mode of the flipped block into a second intra prediction mode based on the adjusted orientation of the first picture being the vertical flip, the unified intermediate coding information of the first picture in the one or more intermediate coding information buffers including the second intra prediction mode.

(8) The method of feature (7), in which the first intra prediction mode is a first angular intra prediction mode corresponding to a first direction; the second intra prediction mode is a second angular intra prediction mode corresponding to a second direction; and the second direction is a vertical flip of the first direction.

(9) The method of feature (7), in which the remapping the first intra prediction mode includes: deriving, using decoder side mode derivation, the second intra prediction mode of the restored block in the restored first picture based on a template of the restored block in the restored first picture, the template in the restored first picture including neighboring reconstructed samples in the restored first picture that are (i) above the restored block and/or (ii) to the left of the restored block in the restored first picture.

(10) The method of any of features (1) to (9), in which the first picture is restricted to be an intra picture (I picture).

(11) A method for video decoding, the method including: receiving a bitstream including information indicating that an orientation of a first picture is adjusted from an original orientation to an adjusted orientation; decoding the adjusted first picture in the adjusted orientation; generating unified intermediate coding information of the first picture based on a unified orientation of a plurality of pictures in a picture buffer, the plurality of pictures in the picture buffer being oriented in the unified orientation, the unified intermediate coding information being stored in one or more intermediate coding information buffers associated with the first picture, the plurality of pictures in the picture buffer including the first picture, the unified orientation being one of (i) the original orientation and (ii) the adjusted orientation; and decoding a second picture based on the unified intermediate coding information of the first picture.

(12) The method of feature (11), in which the adjusted orientation of the first picture is one or more of: a vertical flip when the adjustment is flipping the first picture vertically; a horizontal flip when the adjustment is flipping the first picture horizontally; and a rotation of N×90° when the adjustment is rotating the first picture N×90°, N being an integer that is not zero.

(13) The method of feature (11) or (12), in which the unified orientation is the original orientation; the method includes: restoring the decoded first picture in the adjusted orientation to a restored first picture in the original orientation; and storing the restored first picture in the original orientation in the picture buffer; and the generating includes generating the unified intermediate coding information of the first picture in the original orientation.

(14) The method of feature (13), in which the adjusting the orientation includes a vertical flip of the first picture; intermediate coding information of the first picture in the one or more intermediate coding information buffers includes a first block vector (BV) and a second BV; the first BV is associated with a first block in the flipped first picture in the adjusted orientation and includes a horizontal component BV′0x and a vertical component BV′0y, the second BV is associated with a second block in the flipped first picture in the adjusted orientation and includes a horizontal component BV′2x and a vertical component BV′2y, the second block is above the first block in the flipped first picture in the adjusted orientation; and the generating the unified intermediate coding information includes: flipping the first BV and the second BV into the flipped first BV and the flipped second BV, the flipped first BV including a horizontal component BV0x and a vertical component BV0y, the flipped second BV including a horizontal component BV2x and a vertical component BV2y, the first block associated with the first BV in the flipped first picture being flipped to a first block associated with the flipped first BV in the restored first picture, the second block associated with the second BV in the flipped first picture being flipped to a second block associated with the flipped second BV in the restored first picture, BV0x=BV′0x, BV0y=−BV′0y, BV2x=BV′2x, and BV2y=−BV′2y, and the unified intermediate coding information indicates the flipped first BV, the flipped second BV, and the first block associated with the flipped first BV being above the second block associated with the flipped second BV in the restored first picture.

(15) The method of feature (13), in which the adjusting the orientation includes a vertical flip of the first picture; the decoding the first picture includes: deriving first model parameters of a flipped block in the flipped first picture based on a template of the flipped block in the flipped first picture, the flipped block being a vertical flip of a corresponding block in the first picture in the original orientation; the template in the flipped first picture including neighboring reconstructed samples in the flipped first picture that are (i) above the flipped block and/or (ii) to the left of the flipped block in the flipped first picture; decoding the flipped block in the flipped first picture based on the first model parameters; the restoring includes flipping vertically the reconstructed and flipped first picture to obtain a restored first picture in the original orientation, the restored first picture including a restored block that is a vertical flip of the flipped block that is reconstructed; and the generating the unified intermediate coding information includes: deriving second model parameters of the restored block in the restored first picture based on a template of the restored block in the restored first picture, the template in the restored first picture including neighboring reconstructed samples in the restored first picture that are (i) above the restored block and/or (ii) to the left of the restored block in the restored first picture, the unified intermediate coding information of the first picture in the one or more intermediate coding information buffers including the second model parameters of the restored block in the restored first picture.

(16) The method of feature (13), in which the adjusting the orientation includes a vertical flip of the first picture; the decoding the first picture includes: deriving first model parameters of a flipped block in the flipped first picture based on a reference area in the flipped first picture that is indicated by a block vector (BV) pointing from the flipped block to the reference area of the flipped block, the flipped BV including a horizontal component BVx and a vertical component BVy, the flipped block being a vertical flip of a corresponding block in the first picture in the original orientation; and decoding the flipped block in the flipped first picture based on the first model parameters; the restoring includes flipping vertically the reconstructed and flipped first picture to obtain a restored first picture in the original orientation, the restored first picture including a restored block that is a vertical flip of the flipped block that is reconstructed; and the generating the unified intermediate coding information includes: flipping the BV into a flipped BV, the flipped BV including a horizontal component BV′x that is equal to BVx and a vertical component BV′y that is opposite to BVy, the flipped BV pointing from the restored block to a reference area in the restored first picture; deriving second model parameters of the restored block in the restored first picture based on the reference area in the restored first picture indicated by the flipped BV, the unified intermediate coding information of the first picture in the one or more intermediate coding information buffers including the second model parameters of the restored block in the restored first picture.

(17) The method of feature (13), in which the adjusting the orientation includes a vertical flip of the first picture; the decoding the first picture includes decoding a flipped block in the flipped first picture based on a first intra prediction mode; the restoring includes flipping vertically the decoded and flipped first picture to obtain a restored first picture in the original orientation, the restored first picture including a restored block that is a vertical flip of the flipped block that is decoded; and the generating the unified intermediate coding information includes remapping the first intra prediction mode of the flipped block into a second intra prediction mode based on the adjusted orientation of the first picture being the vertical flip, the unified intermediate coding information of the first picture in the one or more intermediate coding information buffers including the second intra prediction mode.

(18) The method of feature (17), in which the first intra prediction mode is a first angular intra prediction mode corresponding to a first direction; the second intra prediction mode is a second angular intra prediction mode corresponding to a second direction; and the second direction is a vertical flip of the first direction.

(19) The method of feature (17), in which the remapping the first intra prediction mode includes: deriving, using decoder side mode derivation, the second intra prediction mode of the restored block in the restored first picture based on a template of the restored block in the restored first picture, the template in the restored first picture including neighboring reconstructed samples in the restored first picture that are (i) above the restored block and/or (ii) to the left of the restored block in the restored first picture.

(20) A non-transitory computer-readable storage medium storing instructions which when executed by a processor cause the processor to perform a method of encoding a bitstream including: adjusting an orientation of a first picture from an original orientation to an adjusted orientation; encoding, in the bitstream, the adjusted first picture in the adjusted orientation; generating unified intermediate coding information of the first picture based on a unified orientation of a plurality of pictures in a picture buffer, the plurality of pictures in the picture buffer being oriented in the unified orientation, the unified intermediate coding information being stored in one or more intermediate coding information buffers associated with the first picture, the plurality of pictures in the picture buffer including the first picture, the unified orientation being one of (i) the original orientation and (ii) the adjusted orientation; encoding, in the bitstream, a second picture based on the unified intermediate coding information of the first picture; and transmitting the bitstream.

(21) An apparatus of video encoding, including processing circuitry that is configured to perform the method of any of features (1) to (10).

(22) An apparatus of video decoding, including processing circuitry that is configured to perform the method of any of features (11) to (19).

(23) A non-transitory computer-readable storage medium storing instructions which when executed by at least one processor cause the at least one processor to perform the method of any of features (1) to (19).

What is claimed is:

1. A method for video encoding, the method comprising:
adjusting an orientation of a first picture from an original orientation to an adjusted orientation;
encoding, in a bitstream, the adjusted first picture in the adjusted orientation;
generating unified intermediate coding information of the first picture based on a unified orientation of a plurality of pictures in a picture buffer, the plurality of pictures in the picture buffer being oriented in the unified orientation, the unified intermediate coding information being stored in one or more intermediate coding information buffers associated with the first picture, the plurality of pictures in the picture buffer including the first picture, the unified orientation being one of (i) the original orientation and (ii) the adjusted orientation; and
encoding, in the bitstream, a second picture based on the unified intermediate coding information of the first picture.

2. The method of claim 1, wherein the adjusting the orientation comprises one or more of:
flipping the first picture vertically, the adjusted orientation of the first picture being a vertical flip;
flipping the first picture horizontally, the adjusted orientation of the first picture being a horizontal flip; and
rotating the first picture N×90°, the adjusted orientation of the first picture being a rotation of N×90°, N being an integer that is not zero.

3. The method of claim 1, wherein
the unified orientation is the original orientation;
the method includes:
reconstructing the first picture based on the encoded first picture in the adjusted orientation;
restoring the reconstructed first picture in the adjusted orientation to the original orientation; and
storing the restored first picture that is reconstructed and is in the original orientation in the picture buffer; and
the generating includes generating the unified intermediate coding information of the first picture in the original orientation.

4. The method of claim 3, wherein
the adjusting the orientation includes a vertical flip of the first picture;
intermediate coding information of the first picture in the one or more intermediate coding information buffers includes a first block vector (BV) and a second BV;
the first BV is associated with a first block in the flipped first picture in the adjusted orientation and includes a horizontal component BV′₀ₓ and a vertical component BV′_{0y},
the second BV is associated with a second block in the flipped first picture in the adjusted orientation and includes a horizontal component BV′₂ₓ and a vertical component BV′_{2y},
the second block is above the first block in the flipped first picture in the adjusted orientation; and
the generating the unified intermediate coding information includes:
flipping the first BV and the second BV into the flipped first BV and the flipped second BV, the flipped first BV including a horizontal component BV₀ₓ and a vertical component BV_{0y}, the flipped second BV including a horizontal component BV₂ₓ and a vertical component BV_{2y}, the first block associated with the first BV in the flipped first picture being flipped to a first block associated with the flipped first BV in the restored first picture, the second block associated with the second BV in the flipped first picture being flipped to a second block associated with the flipped second BV in the restored first picture,
BV₀ₓ=BV′₀ₓ, BV_{0y}=-BV′0y, BV₂ₓ =BV′₂ₓ, and BV_{2y}=-BV′_{2y}, and
the unified intermediate coding information indicates the flipped first BV, the flipped second BV, and the first block associated with the flipped first BV being above the second block associated with the flipped second BV in the restored first picture.

5. The method of claim 3, wherein
the adjusting the orientation includes a vertical flip of the first picture;
the encoding the first picture includes:
deriving first model parameters of a flipped block in the flipped first picture based on a template of the flipped block in the flipped first picture, the flipped block being a vertical flip of a corresponding block in the first picture in the original orientation;
the template in the flipped first picture including neighboring reconstructed samples in the flipped first picture that are (i) above the flipped block and/or (ii) to the left of the flipped block in the flipped first picture;
encoding the flipped block in the flipped first picture based on the first model parameters;
the restoring includes flipping vertically the reconstructed and flipped first picture to obtain a restored first picture in the original orientation, the restored first picture including a restored block that is a vertical flip of the flipped block that is reconstructed; and
the generating the unified intermediate coding information includes:
deriving second model parameters of the restored block in the restored first picture based on a template of the restored block in the restored first picture, the template in the restored first picture including neighboring reconstructed samples in the restored first picture that are (i) above the restored block and/or (ii) to the left of the restored block in the restored first picture, the unified intermediate coding information of the first picture in the one or more intermediate coding information buffers including the second model parameters of the restored block in the restored first picture.

6. The method of claim 3, wherein
the adjusting the orientation includes a vertical flip of the first picture;
the encoding the first picture includes:
deriving first model parameters of a flipped block in the flipped first picture based on a reference area in the flipped first picture that is indicated by a block vector (BV) pointing from the flipped block to the reference area of the flipped block, the flipped BV including a horizontal component BVₓ and a vertical component BV_{y}, the flipped block being a vertical flip of a corresponding block in the first picture in the original orientation; and
encoding the flipped block in the flipped first picture based on the first model parameters;
the restoring includes flipping vertically the reconstructed and flipped first picture to obtain a restored first picture in the original orientation, the restored first picture including a restored block that is a vertical flip of the flipped block that is reconstructed; and
the generating the unified intermediate coding information includes:
flipping the BV into a flipped BV, the flipped BV including a horizontal component BV′ₓ that is equal to BVₓ and a vertical component BV′_{y} that is opposite to BV_{y}, the flipped BV pointing from the restored block to a reference area in the restored first picture;
deriving second model parameters of the restored block in the restored first picture based on the reference area in the restored first picture indicated by the flipped BV, the unified intermediate coding information of the first picture in the one or more intermediate coding information buffers including the second model parameters of the restored block in the restored first picture.

7. The method of claim 3, wherein
the adjusting the orientation includes a vertical flip of the first picture;
the encoding the first picture includes encoding a flipped block in the flipped first picture based on a first intra prediction mode;
the restoring includes flipping vertically the reconstructed and flipped first picture to obtain a restored first picture in the original orientation, the restored first picture including a restored block that is a vertical flip of the flipped block that is reconstructed; and
the generating the unified intermediate coding information includes remapping the first intra prediction mode of the flipped block into a second intra prediction mode based on the adjusted orientation of the first picture being the vertical flip, the unified intermediate coding information of the first picture in the one or more intermediate coding information buffers including the second intra prediction mode.

8. The method of claim 7, wherein
the first intra prediction mode is a first angular intra prediction mode corresponding to a first direction;
the second intra prediction mode is a second angular intra prediction mode corresponding to a second direction; and
the second direction is a vertical flip of the first direction.

9. The method of claim 7, wherein the remapping the first intra prediction mode comprises:
deriving, using decoder side mode derivation, the second intra prediction mode of the restored block in the restored first picture based on a template of the restored block in the restored first picture, the template in the restored first picture including neighboring reconstructed samples in the restored first picture that are (i) above the restored block and/or (ii) to the left of the restored block in the restored first picture.

10. The method of claim 1, wherein the first picture is restricted to be an intra picture (I picture).

11. A method for video decoding, the method comprising:
receiving a bitstream including information indicating that an orientation of a first picture is adjusted from an original orientation to an adjusted orientation;
decoding the adjusted first picture in the adjusted orientation; and
generating unified intermediate coding information of the first picture based on a unified orientation of a plurality of pictures in a picture buffer, the plurality of pictures in the picture buffer being oriented in the unified orientation, the unified intermediate coding information being stored in one or more intermediate coding information buffers associated with the first picture, the plurality of pictures in the picture buffer including the first picture, the unified orientation being one of (i) the original orientation and (ii) the adjusted orientation; and
decoding a second picture based on the unified intermediate coding information of the first picture.

12. The method of claim 11, wherein the adjusted orientation of the first picture is one or more of:
a vertical flip when the adjustment is flipping the first picture vertically;
a horizontal flip when the adjustment is flipping the first picture horizontally; and
a rotation of N×90^{o} when the adjustment is rotating the first picture N×90°, N being an integer that is not zero.

13. The method of claim 11, wherein
the unified orientation is the original orientation;
the method includes:
restoring the decoded first picture in the adjusted orientation to a restored first picture in the original orientation; and
storing the restored first picture in the original orientation in the picture buffer;
and
the generating includes generating the unified intermediate coding information of the first picture in the original orientation.

14. The method of claim 13, wherein
the adjusting the orientation includes a vertical flip of the first picture;
intermediate coding information of the first picture in the one or more intermediate coding information buffers includes a first block vector (BV) and a second BV;
the first BV is associated with a first block in the flipped first picture in the adjusted orientation and includes a horizontal component BV′₀ₓ and a vertical component BV′_{0y},
the second BV is associated with a second block in the flipped first picture in the adjusted orientation and includes a horizontal component BV′₂ₓ and a vertical component BV′_{2y},
the second block is above the first block in the flipped first picture in the adjusted orientation; and
the generating the unified intermediate coding information includes:
flipping the first BV and the second BV into the flipped first BV and the flipped second BV, the flipped first BV including a horizontal component BV₀ₓ and a vertical component BV_{0y}, the flipped second BV including a horizontal component BV₂ₓ and a vertical component BV_{2y}, the first block associated with the first BV in the flipped first picture being flipped to a first block associated with the flipped first BV in the restored first picture, the second block associated with the second BV in the flipped first picture being flipped to a second block associated with the flipped second BV in the restored first picture,
BV₀ₓ=BV′₀ₓ, BV_{0y}=−BV′_{0y}, BV₂ₓ=BV′₂ₓ, and BV_{2y}=−BV′_{2y}, and
the unified intermediate coding information indicates the flipped first BV, the flipped second BV, and the first block associated with the flipped first BV being above the second block associated with the flipped second BV in the restored first picture.

15. The method of claim 13, wherein
the adjusting the orientation includes a vertical flip of the first picture;
the decoding the first picture includes:
deriving first model parameters of a flipped block in the flipped first picture based on a template of the flipped block in the flipped first picture, the flipped block being a vertical flip of a corresponding block in the first picture in the original orientation;
the template in the flipped first picture including neighboring reconstructed samples in the flipped first picture that are (i) above the flipped block and/or (ii) to the left of the flipped block in the flipped first picture;
decoding the flipped block in the flipped first picture based on the first model parameters;
the restoring includes flipping vertically the reconstructed and flipped first picture to obtain a restored first picture in the original orientation, the restored first picture including a restored block that is a vertical flip of the flipped block that is reconstructed; and
the generating the unified intermediate coding information includes:
deriving second model parameters of the restored block in the restored first picture based on a template of the restored block in the restored first picture, the template in the restored first picture including neighboring reconstructed samples in the restored first picture that are (i) above the restored block and/or (ii) to the left of the restored block in the restored first picture, the unified intermediate coding information of the first picture in the one or more intermediate coding information buffers including the second model parameters of the restored block in the restored first picture.

16. The method of claim 13, wherein
the adjusting the orientation includes a vertical flip of the first picture;
the decoding the first picture includes:
deriving first model parameters of a flipped block in the flipped first picture based on a reference area in the flipped first picture that is indicated by a block vector (BV) pointing from the flipped block to the reference area of the flipped block, the flipped BV including a horizontal component BVₓ and a vertical component BV_{y}, the flipped block being a vertical flip of a corresponding block in the first picture in the original orientation; and
decoding the flipped block in the flipped first picture based on the first model parameters;
the restoring includes flipping vertically the reconstructed and flipped first picture to obtain a restored first picture in the original orientation, the restored first picture including a restored block that is a vertical flip of the flipped block that is reconstructed; and
the generating the unified intermediate coding information includes:
flipping the BV into a flipped BV, the flipped BV including a horizontal component BV′ₓ that is equal to BVₓ and a vertical component BV′_{y} that is opposite to BV_{y}, the flipped BV pointing from the restored block to a reference area in the restored first picture;
deriving second model parameters of the restored block in the restored first picture based on the reference area in the restored first picture indicated by the flipped BV, the unified intermediate coding information of the first picture in the one or more intermediate coding information buffers including the second model parameters of the restored block in the restored first picture.

17. The method of claim 13, wherein
the adjusting the orientation includes a vertical flip of the first picture;
the decoding the first picture includes decoding a flipped block in the flipped first picture based on a first intra prediction mode;
the restoring includes flipping vertically the decoded and flipped first picture to obtain a restored first picture in the original orientation, the restored first picture including a restored block that is a vertical flip of the flipped block that is decoded; and
the generating the unified intermediate coding information includes remapping the first intra prediction mode of the flipped block into a second intra prediction mode based on the adjusted orientation of the first picture being the vertical flip, the unified intermediate coding information of the first picture in the one or more intermediate coding information buffers including the second intra prediction mode.

18. The method of claim 17, wherein
the first intra prediction mode is a first angular intra prediction mode corresponding to a first direction;
the second intra prediction mode is a second angular intra prediction mode corresponding to a second direction; and
the second direction is a vertical flip of the first direction.

19. The method of claim 17, wherein the remapping the first intra prediction mode comprises:
deriving, using decoder side mode derivation, the second intra prediction mode of the restored block in the restored first picture based on a template of the restored block in the restored first picture, the template in the restored first picture including neighboring reconstructed samples in the restored first picture that are (i) above the restored block and/or (ii) to the left of the restored block in the restored first picture.

20. A non-transitory computer-readable storage medium storing instructions which when executed by a processor cause the processor to perform a method of encoding a bitstream comprising:
adjusting an orientation of a first picture from an original orientation to an adjusted orientation ;
encoding, in the bitstream, the adjusted first picture in the adjusted orientation;
generating unified intermediate coding information of the first picture based on a unified orientation of a plurality of pictures in a picture buffer, the plurality of pictures in the picture buffer being oriented in the unified orientation, the unified intermediate coding information being stored in one or more intermediate coding information buffers associated with the first picture, the plurality of pictures in the picture buffer including the first picture, the unified orientation being one of (i) the original orientation and (ii) the adjusted orientation;
encoding, in the bitstream, a second picture based on the unified intermediate coding information of the first picture; and
transmitting the bitstream.
